(19) United States
(12) Patent Application Publication
(10) Pub. No.: US 2023/0244197 A1
(43) Pub. Date: Aug. 3, 2023

(54) MACHINE-LEARNING-ENHANCED DISTRIBUTED ENERGY RESOURCE MANAGEMENT SYSTEM

(71) Applicant: EnerAllies, Inc., Los Altos, CA (US)

(72) Inventors: Stephen C. Maruyama, Aptos, CA (US); Robert S. Keil, Los Altos, CA (US)

(21) Appl. No.: 18/101,519

(22) Filed: Jan. 25, 2023

Related U.S. Application Data
(60) Provisional application No. 63/305,653, filed on Feb. 1, 2022.

(51) Int. Cl. G05B 19/042; G06N 20/00

(52) U.S. Cl. CPC G05B 19/042; G06N 20/00; G05B 2219/2639

(57) ABSTRACT

Techniques for providing a machine learning-enhanced distributed energy resource management system are provided. In one technique, a machine-learning (ML) model is trained based on a training dataset that comprises historical demand response (DR) event data and historical weather data. The trained ML model is used to predict a load capacity to be made available for an upcoming DR event based, at least in part, on current DR event data and weather data. The predicted load capacity made available for an upcoming DR event is determined to be not sufficient to balance energy supply and demand during the upcoming DR event. Responsive to this determination, one or more load capacity increasing actions are automatically performed. Examples of such actions include increasing a level of participation of a set of dynamically-enrolled customers and causing a request for additional participation in load-shedding to be sent to one or more customers.

### BENEFIT OF PRIORITY AND RELATED APPLICATIONS

This application claims the benefit under 35 U.S.C. § 119(e) of provisional application 63/305,653, filed Feb. 1, 2022, by Stephen C. Maruyama et al., the entire contents of which is hereby incorporated by reference.

This application is related to the following, each of which is hereby incorporated by reference as if fully set forth herein:
U.S. application Ser. No. 17/525,754, titled “Intelligent Ventilation Monitoring, Controls and Optimization”, filed Nov. 12, 2021;
U.S. application Ser. No. 17/327,444, titled “FORECAST-BASED AUTOMATIC SCHEDULING OF A DISTRIBUTED NETWORK OF THERMOSTATS WITH LEARNED ADJUSTMENT”, filed May 21, 2021;
U.S. application Ser. No. 16/670,853, titled “ENERGY MANAGEMENT COMPUTER SYSTEM”, filed Oct. 31, 2019; and
U.S. application Ser. No. 16/773,803, titled “ENERGY EFFICIENCY AND COMFORT OPTIMIZATION THROUGH EXTREME WEATHER ADAPTIVITY AND AI”, filed Jan. 27, 2020, referred to herein as the “Extreme Weather Application”.

### BACKGROUND

There is a major global push for decarbonization to deal with climate change. Major developed economies have a stated goal to achieve a “Net-Zero Economy” by 2050, which for the U.S. requires a “Net-Zero” electric grid by 2035. The implications for the electric grid are profound. Electric grids fundamentally depend on a balance between electricity supply and demand to function properly. However, in order for the U.S. (and other developed countries) to achieve net-zero economies, electric grids will undergo drastic changes in both supply and demand in a relatively short amount of time. For example, the percentage of energy that is supplied from clean energy sources for the U.S. grid will need to increase from around 40% (in 2020) to around 80%-90%, with a projected three to three-and-a-half times increase in the percentage of power from intermittent renewables such as solar and wind-based power over the target timeframe. This assumes the energy supplied from hydroelectricity and nuclear power—the latter of which in 2020 supplied 20% of the U.S. grid's energy—remains constant; the nuclear assumption appears to be optimistic given that seven U.S. nuclear reactor retirements have already been announced through 2025, with total generating capacity equal to roughly 7% of U.S. nuclear capacity planned to be removed from the U.S. grid. On the demand side of the electric grid, part of achieving a net-zero economy is to electrify transportation and heating mechanisms, which will drive a large (in the order of 80%) increase in demand for electrical power relative to 2020 demand levels.

Given the magnitude of changes on both supply and demand side, a critical challenge becomes achieving a balanced grid. Given the rapid changes in the supply and demand components of the electric grid, it is projected that the U.S. electrical grid infrastructure is reaching a strategic inflection point, i.e., the nature of balancing the electricity infrastructure must change to meet the changing nature of the supply and rapid increase in demand for electricity. One example of the failure to balance the grid occurred in California from Aug. 14-21, 2020. During this time, California experienced Stage 3 emergency conditions as circumstances caused rolling blackouts over several days and left the CAISO (California Independent System Operator), a non-profit group which maintains the reliability of the statewide grid, with forecasted daily capacity shortages of up to 4,400 MW. A white paper by an industry vendor described four causes of these emergency conditions: (A) heat wave (extreme weather); (B) unplanned gas-powered generation facilities went offline; (C) interrupted renewable energy generation as wind power unexpectedly declined; and (D) lack of sufficient dispatchable reserve and emergency capacity.

One particular area that must be addressed to properly balance the grid is balancing the grid during periods of peak demand. Another area that must be addressed is management and aggregation of the explosion of DERs at the grid edge, which involves providing an ‘on-ramp’ of these distributed energy sources into the electricity grid and managing how much energy is provided into the grid and demanded from the grid with respect to the DERs. For example, management of thermostat devices during peak hours can reduce electricity demand during those times, which increases the stability of the system. Yet another problem is how to absorb the resulting energy price increases that has resulted from (A) the reduced supply of hydrocarbon-based fuel sources during this energy transition; and (B) the supply-side redundancy required in the energy system to offset shortfalls of energy production when intermittent supply sources (e.g., hydro, wind, or solar) fail to produce adequate energy for demand requirements.

One strategy for dealing with at least some of these issues is to create more classical energy sources, such as gas peaker plants. These plants require many resources to create, including a large land-use footprint, and have a high environmental impact including production of CO₂ and methane, and also requiring mining of natural resources. There is some small-medium amount of safety risk in connection with building and maintaining such classical energy sources.

Another strategy for dealing with at least some of these issues is using batteries to store excess power generated by distributed energy resources (DERs). However, generating the quantity of battery hardware required to balance the grid would be prohibitively expensive and is already challenging the global supply chain to procure key raw material inputs (e.g., mining for “rare earth” elements required for batteries and wind turbines). As such, it is unrealistic for utilities to rely on battery storage as the only clean energy tool as the main mechanism to offset the intermittency of renewables during peak demand periods. Furthermore, batteries require substantial land for placement of the batteries, and have some negative environmental impact, including mining the resources required to create the batteries and the problem of disposing of waste generated in connection with production and disposal of the batteries. There is also a potential safety risk of battery maintenance, such as the potential of batteries catching fire and producing toxic smoke.

Given the issues inherent in these strategies for dealing with peak demand issues, it would be beneficial to address these issues with the electrical grid with complementary technologies that are lower-cost, easy to apply widely, and that involve a lower safety risk.

### BRIEF DESCRIPTION OF THE DRAWINGS

In the drawings:

FIG. 1 is a block diagram that depicts an example DERMs, in an embodiment;

FIG. 2 is a block diagram that depicts multiple tools that a mobile application implements and/or facilitates, in an embodiment;

FIG. 3 is a block diagram that depicts various input data that may be used to train and/or update one or more machine-learned models, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### General Overview

Accordingly, distributed energy resources (DERs)—including, at the edges of the electricity grids, solar cells with battery storage, thermostats that control heating and air conditioning units (and the energy management software systems that control thermostats via the cloud), and electric vehicles (EVs) with two-way ‘vehicle-to-grid’ capabilities—will play a large part in facilitating the flexible increase in supply of electricity, and/or reduction in demand for electricity, to ensure the electric grid remains balanced.

One aspect of distributed energy resources management systems (DERMs) is thermostat control, which includes pre-conditioning, load-shifting, and load-shedding. By performing these thermostat controls using advanced machine-learning-based algorithms, significant energy conservation and/or electricity demand reduction may be affected, which results in greater stability for the electrical grid. The thermostats may be controlled via cloud-based solutions, which decreases the cost of DERMs system maintenance. The physical space requirements of computing devices required to implement software-based solutions is relatively low, with relatively low environmental impact (e.g., low CO₂ production), and the safety of maintenance of these systems has been proven by years of development and use of datacenters with large numbers of the required computing devices.

In the U.S., one or more states (e.g., California) that have experienced wide proliferation of DERs, especially solar energy sources that produce energy during the daylight hours, generally experience the lowest net demand on the electricity grid during the day and the highest net demand during evening hours when the light outside fades and people return to their homes. This pattern of demand is referred to as the “duck curve” phenomenon. Further, this net peak demand can be amplified during extreme weather events, such as (A) heat waves (demand for air conditioning spikes), (B) wild fires (daytime solar generation declines as smoke obscures the sun), and (C) droughts (water flow powering hydroelectricity drops). (To the extent that many climate scientists assert that climate change is causing both the increased frequency and magnitude of extreme weather events, these factors could become more significant in the coming years in addressing peak demand and balancing the grid, at least until global CO₂ levels have sufficiently dropped.) Of the roughly 6 million U.S. commercial buildings, approximately 90% are less than 50,000 square feet, and these buildings are considered “light commercial”, a large portion of which are retail buildings (e.g., in strip malls), that are well-able to conserve energy during these peak hours given that the population of these light commercial buildings generally is reduced at night. DERMs that are designed for light commercial applications may be used to manage supply/demand of electricity during these peak hours to minimize the risk of brown-outs/black-outs.

According to various embodiments, techniques described herein comprise training a machine-learning model based on a training dataset comprising one or more of historical DR event data and historical weather data. The historical DR event data comprises one or more of historical load-shedding participation data for historical DR events or historical incentive compensation pricing data. Weather data comprises one or more of extreme weather probability projections, weather forecast data, or detected weather conditions. Each training instance in the training dataset includes data about a different historical DR event and data about weather during and/or around that historical DR event. Each training instance also includes a label (for the dependent variable) indicating an amount of load capacity and type of DER that was made available during the corresponding historical DR event, as well as whether the DER was applied for electricity demand reduction (e.g., through changing setpoints on a thermostat) or additional supply (e.g., through battery storage). Other data may include location of the weather event, location of the customer site, duration of the weather event, time of year, outside temperature, type of customer, etc. The trained machine-learning model is used to predict a load capacity made available for an upcoming DR event based, at least in part, on current DR event data and on weather data. The current DR event data comprises one or more of real-time load-shedding participation data for an upcoming DR event or current incentive compensation pricing data. It is determined whether the predicted load capacity made available for an upcoming DR event is sufficient to balance energy supply and demand during the upcoming DR event. The electric grid supply and demand balancing requirement may be on a regional level, a metro level, a zip code level, or even potentially a given grid substation level. Responsive to determining that the predicted load capacity made available for an upcoming DR event is not sufficient to balance the energy supply and demand during the upcoming DR event, one or more load capacity increasing actions (either reducing demand or adding supply) are automatically performed. A load capacity increasing action comprises one of increasing incentive compensation offered for the upcoming DR event, increasing a level of participation of a set of dynamically-enrolled customers, or causing a request for additional participation in load-shedding to be sent to one or more customers. Increasing the level of participation of a set of dynamically-enrolled customers may involve increasing a participation tier of a customer or increasing the number of sites and/or DERs that will participate in a DR event. For example, a customer has 100 sites signed up to participate in DR events within a given tier, including 400 DERs (average of 4 DERs per site). But for a given DR event in which there is a shortfall of capacity, the customer has only agreed to have 50 of the 100 sites participate, and/or only 100 of the 400 DERs. A request to the customer may be to add more sites, add more DERs among the participating sites, or both.

According to various embodiments, techniques described herein comprise training a machine-learning model based on a training dataset comprising: historical load-shedding participation data, historical incentive compensation pricing data, and historical context data. The context data comprises one or more of extreme weather probability projections, weather forecast data, detected weather conditions, business/enterprise activity data (including particular day(s) of the week and particular week(s) of the year that a business/enterprise is open and/or closed as well as when DR events occur) for DR events, customer feedback data, and/or cost of living data. Each training instance in the training dataset includes data about a different historical DR event and data about the context associated with that historical DR event, including an amount of load capacity that was made available during that historical DR event. Each training instance also includes a label indicating a level of compensation to one or more customers for participating in the corresponding historical DR event. A request to predict a level of compensation for an upcoming DR event to result in a particular amount of load capacity made available for the upcoming DR event is received. The trained machine-learning model is used to predict a level of compensation based, at least in part, on real-time load-shedding participation data, current incentive compensation pricing data, and current context data. The predicted level of compensation is returned in a response to the request. The predicted level of compensation may be made for a particular customer, a group or class of customers, or all known customers that might participate in an upcoming DR event.

According to various embodiments, techniques described herein comprise training a machine-learning model based on a training dataset comprising one or more of customer satisfaction information, historical DER behavior during DR events, historical pre-conditioning actions taken in preparation for DR events, one or more environmental metrics during historical DR events, or historical load-shedding actions taken during DR events. The trained machine-learning model is used to predict one or more pre-conditioning actions to take for a particular space (or site) in preparation for an upcoming DR event. Prior to the upcoming DR event, the predicted one or more pre-conditioning actions are automatically caused to be taken for the particular space. According to various embodiments, the techniques further comprise, after the DR event, receiving customer feedback regarding the DR event from a user associated with the particular space. Additional training of the machine-learning model is performed based, at least in part, on the customer feedback.

### 1. Phased Approach to DERMs

According to various embodiments, a multi-phased architecture for a DERMs allows for intelligent DER aggregation with optimal opt-ins for peak demand management programs. The phased architecture includes the following six general phases:

Phase 1. Onboarding/Retention

Phase 2. Planning and Forecasting

Phase 3. Real-Time Monitoring

Phase 4. Dispatch and Controls

Phase 5. Notifications

Phase 6. Post-Event Analysis and Reporting

This multi-phased approach may be implemented in its entirety, or one or more portions of the program, including one or more techniques within one or more phases, may be implemented independently

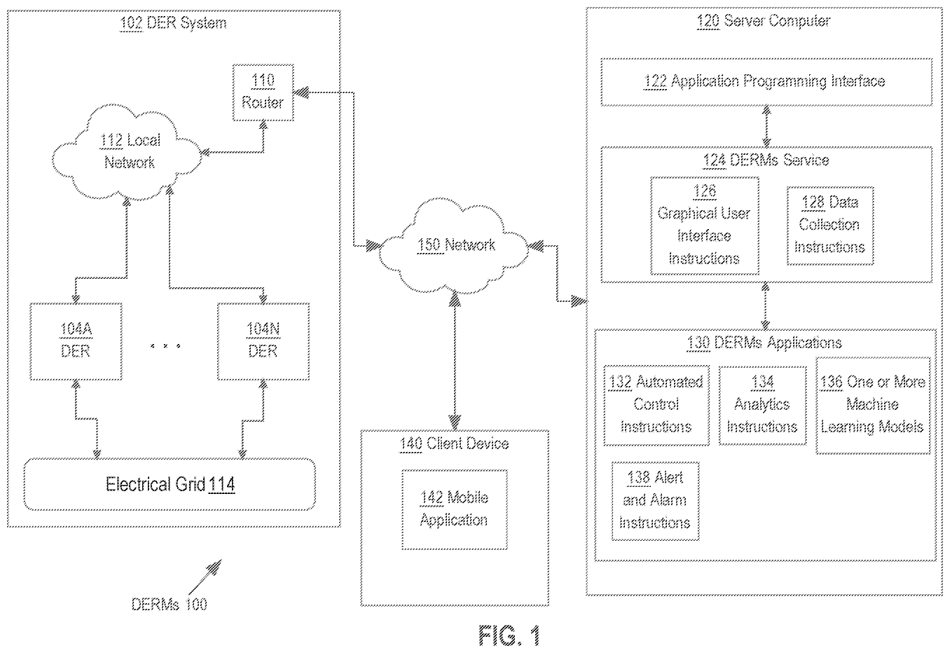

FIG. 1 is a block diagram that depicts an example DERMs 100 that is configured to implement one or more techniques described herein. In FIG. 1, DERMs 100 is depicted as managing, e.g., via an open API (such as Amazon's AWS IoT API), a DER system 102 with one or more DERs 104A-N that represent any kind of DER such as thermostat devices. Specifically, this phased approach may be used to control any number of DERs, including thermostat controls, rooftop controls for ventilation (demand control ventilation “DCV”/variable speed drive “VSD” controls), solar, battery or other storage, electric vehicle (EV) fleet with bi-directional batteries (“V2G”), back-up generators, etc.

Taking electric vehicle fleets as an example, during the day, the vehicles can be plugged into the grid to recharge, generally during a time when solar power is available and time-of-use (“TOU”) pricing is at its lowest levels. At night, the fully-charged vehicles are docked and thereby connected into a building's electrical circuits. DERMs 100 may be used to aggregate the power stored in the batteries (or other storage devices), to access and use the stored power as needed to supplement supply for the electric grid. Distributed batteries are a powerful resource for augmenting the energy supply during Demand Response (DR) events.

For example, a university campus maintains a fleet of 100 golf carts that are configured with solar panels to continuously charge the cart batteries during the day. At night, the golf carts are docked with a network connection and connection to an electrical grid 112, as depicted for DERs 104A-N in FIG. 1. DERMs 100 may cause the batteries to be drained to a particular watermark percentage (e.g., 50%) without affecting the ability of university personnel to use the vehicles the subsequent day. Thus, DERMs 100 may be used to access the 100 fully-charged golf cart batteries to provide power to the university, as needed, or to sell to the utility company to augment general supply.

According to various embodiments, electrical grid 114 that is conductively coupled to DERs 104A-N comprises one or more electrical circuits that allow a docked DER 104 to draw and/or send electricity through the grid, i.e., “bi-directional” functionality. According to various embodiments, DERs 104A-N are connected to network 150 via any kind of network, such as a wired ethernet LAN implementing local network 112 that then connects to a router 110, or a Wi-Fi access point implementing local network 112 that then connects to router 110, or a cellular data modem implementing local network 112 that wirelessly connects to network 150 (which is an implementation that omits router 110), etc.

Thus, DERMs 100 may be used for:
Centralized control, monitoring, and aggregation of DERs;
Pre-conditioning, load-shedding, comfort optimization, and Extreme Weather Adaptation algorithms;
Real-time visibility to, and/or control of, HVAC roof-top units, ventilation, and DCV performance with analytics; and
Analytics reports and insights on energy usage & savings.
   DERMs 100 is scalable to control thousands of sites & devices.

### 2. Mobile App for Customer Acquisition/Onboarding/Retention

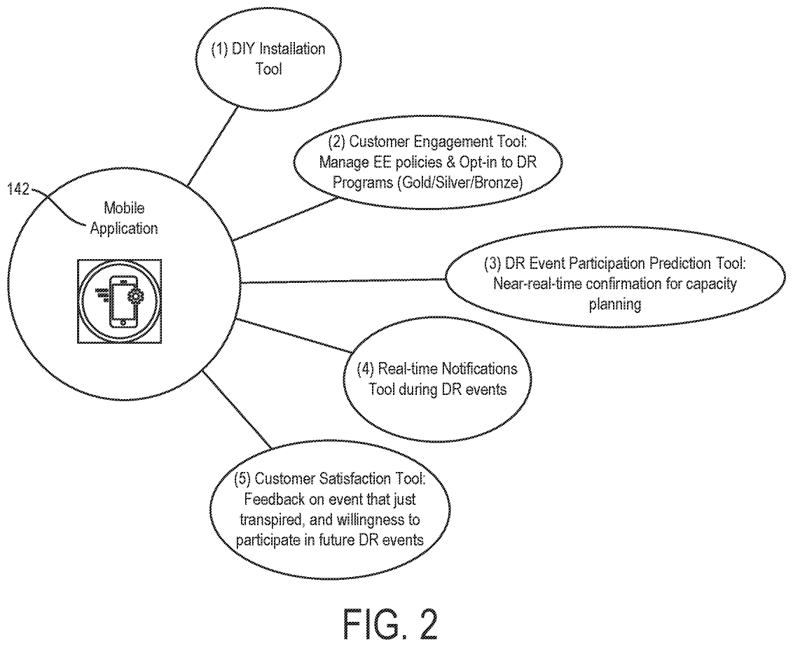

According to various embodiments, client device 140 runs a mobile application 142, which may be implemented in any way, including as a stand-alone application, as an application running within a browser of client device 140, etc. Mobile application 142 causes display of GUIs based on graphical user interface data received from DERMs service 124. As depicted in FIG. 2, mobile application 142 facilitates one or more of the following: (1) DIY installation tool, (2) customer engagement tool, (3) Demand Response (DR) event participation prediction tool, (4) real-time notifications tool during DR events, and (5) customer satisfaction tool. According to various embodiments, one or more of these aspects of mobile application 142 (such as functions 2, 3, and 5) utilize machine learning to increase the accuracy of the functions. According to various embodiments, the functions of mobile application 142 facilitate user engagement with the phases of DERMs management described herein.

### 3. Phase 1: Onboarding/Retention

According to the first phase, DERMs 100 may be used to perform onboarding for customers, including tasks required to allow DERMs 100 to access one or more DERs of the customers. Herein, a “customer” is used to refer to an entity/company/business/association that owns or operates more or more sites, each of which has one or more DERs. If a customer is a non-human entity, then the customer may employ or direct one or more authorized users (or representatives of the customer) to interact with DERMs 100 on behalf of the customer, such as selecting which site will participate in a DR event and at what level or tier of participation (if multiple levels or tiers are available). A customer may have one or more sites. A customer with multiple sites may participate in a DR event by opting to have (a) all of those sites participate in the DR event or (b) only a strict subset of those sites participate in the DR event.

A site may have one or more DERs. A customer participating in a DR event may opt to have all DERs at a participating site to participate in a DR event. Alternatively, a customer may opt to have only a strict subset of DERs at a participating site to participate in a DR event. For example, a customer may have (i) a first site with no DERs participating in a DR event, (ii) a second site with a strict subset of DERs at the second site participating in the DR event, and (iii) all DERs at a third site participating in the DR event.

A DER can serve to either reduce demand or add supply, and both functions may be available at a given site for a given DR event, but with some unpredictable variations. For example, during a heat wave, in the evenings, set-points on thermostats are able to be increased, which will reduce AC usage and thereby reduce demand. Battery storage may be available on standby (due to daytime solar generation) to add supply. However, an EV with V2G might not be accessible as anticipated because the EV's batteries had been drawn down lower than normal due to daytime driving coupled with high AC usage, due to the heat wave.

As another example, during extreme cold, thermostats with set-points are able to be decreased, which will reduce heating usage and thereby reduce demand (presuming electrical heating). Battery storage may be available on standby to add supply, but an EV with V2G might not be accessible because the EV's batteries had been drawn down lower than normal due to cold temperatures, draining the batteries faster than expected.

A customer's participation is granular to the level of quantifying a number individual DERs participating at a site as well as quantifying a number of sites participating for the customer. For example, via mobile application 142, a user may customize configuration of a ventilation or conditioning devices and thermostats for energy efficiency (EE) based on customer-specific energy policies provided by the user via the application. As another example, via mobile application 142, a user may register a customer for participation in a DR program, e.g., using one or more tools in mobile application 142 for easily opting into or out of DR programs. Furthermore, mobile application 142 performs one or more customer satisfaction (retention) actions, such as keeping customers abreast of active DR events, offering multiple DR options/plans, establishing customer satisfaction reports, and/or providing updates on customer DR savings.

Furthermore, mobile application 142 may provide a DIY installation tool that automates installation and/or configuration steps for one or more DERs, such as thermostats. For example, mobile application 142 allows a user to provide information for DERs to be managed, including site identities, DERs on the sites, desired thermostat setpoints, ventilation quality or comfort ranges, etc. According to various embodiments, once the information for the customers' DERs is input into the system, server computer 120 provides, via mobile application 142, a key (such as a unique sequence of characters) that provides access to the DER information for the user. The user may then provide this key to a DER maintenance professional to provide the professional independent access to the configuration of the DERs that the professional is to maintain. Mobile application 142 maintains a copy of the key to provide the user access to the DER information in DERMs 100.

Mobile application 142 further acts as a customer engagement tool to offer enrollment into DR programs. A utility company may use mobile application 142 to periodically communicate with customers to promote EE, DR, and/or clean energy programs (solar/storage/EV). For example, information may be provided via mobile application 142 regarding an estimated amount of money that may be saved by enrolling in an energy efficiency program. These estimates may be based on similar sites, or may be based on information gathered for the target site (e.g., times of known low occupancy and the amount of energy used to heat or cool the spaces of the site during such low occupancy times).

3.1. DR Management Programs

As a further example, information provided to promote enrollment in a DR management program may include an amount of money that will be paid as incentives in various forms, including rebates, to a customer to opt into the program, as well as estimated amounts of money that will be saved by the customer by reducing energy usage during DR events. The customer satisfaction actions that may be performed by mobile application 142, indicated herein, may also be used to promote enrollment in a DR management program.

DR management programs may be associated with multiple tiers of participation, each of which is associated with respective levels of participation and compensation. For example, a gold tier may have the highest level of compensation and come with the highest commitment to performing load-shedding actions during a DR event, a silver tier may be associated with mid-range levels of commitment and compensation, and a bronze tier may be associated with low levels of commitment and compensation. To illustrate, on a particular day during an expected heat wave, a customer may opt into a gold tier of load-shedding participation by committing to turn the thermostat to 90° F. for four hours for $200 compensation, a silver tier of load-shedding participation by committing to turn the thermostat to 90° F. for two hours for $100 compensation, or a bronze tier of load-shedding participation by committing to turn the thermostat to 90° F. for one hour for $50 compensation. As another example, on the particular day during an expected heat wave, a customer may opt into a gold tier of load-shedding participation by committing to turn the thermostat to 90° F. for four hours for $200 compensation, a silver tier of load-shedding participation by committing to turn the thermostat to 85° F. for four hours for $100 compensation, or a bronze tier of load-shedding participation by committing to turn the thermostat to 80° F. for four hours for $50 compensation. As yet another example, during an expected two-week heat wave, a customer may opt into a gold tier of load-shedding participation by committing to turn the thermostat to 90° F. for sixteen total hours (during peak time of 5-9 PM on any day of the heat wave) for $800 compensation, a silver tier of load-shedding participation by committing to turn the thermostat to 90° F. for eight total hours for $400 compensation, or a bronze tier of load-shedding participation by committing to turn the thermostat to 90° F. for four total hours for $200 compensation. As yet another example, the tiers may be based on the number of DR events supported in a given Summer peak season, such as Gold: 20 DR events, Silver: 15 DR events, Bronze: 10 DR events, with each DR event providing a minimum of 2 hours of load-shedding by turning the thermostat to a minimum of 90° F. Compensation may be in the form of electricity bill rebates.

Another example of tiers includes Platinum (most aggressive DR participating program), Gold, Silver, Bronze, and Basic (least aggressive DR participating program). Also, DR participating programs may apply to HVAC management, Electric Vehicle (EV) management, Solar Panel management (including Solar Inverter management), and/or Battery management. Combining these example tiers with these areas of management, the following is an example of a DR program offering:

Platinum Service
HVAC Management: Enabled
   Pre-cooling: Y
   Set Point: 85f
   DCV/VSD: 90%
Electric Vehicle (EV) Management: Enabled
   EV charging during DR window: disabled
Solar Panel Management: Enabled
   Enable SP: all
Battery Management: Enabled
   Battery discharge level to 25%
   Switch to battery usage: 100%
   Discharge battery to Grid up to discharge level

Gold . . .

Silver . . .

Bronze . . .

Basic:
HVAC Management: Enabled
   Pre-cooling: N
   Set Point: 76f
   DCV/VSD: 20%
Electric Vehicle (EV) Management: Disabled
   EV charging during DR window: enabled
Solar Panel Management: Enabled
   Enable SP: all
Battery Management: Disabled
   Battery discharge level to 50%
   Switch to battery usage: 100%
   Discharge battery to Grid up to discharge level

### 4. Phase 2: Planning and Forecasting

DERMs 100 may also be used for planning and forecasting. For example, server computer 120 records, in a database: (a) historical per-event DR load-shedding program participation, such as levels to which customers participated in load shedding, or measures taken by customers to load shed, or counts of customers that opted into load-shedding for a DR event, etc. (where historical per-event DR load-shedding program participation may include contextual information such as actual weather readings, efforts made to opt customers into load-shedding for the DR event, etc.); (b) historical behavior of DR participation based on different weather conditions; (c) weather forecasts; (d) extreme weather probability projections; (e) actual weather readings, such as outside air temperature (OAT), humidity, storm conditions, extreme weather conditions; etc. Based on this information, DERMs 100 generates forecasting predictions, e.g., for DR event program participation, weather, projected aggregate load capacity made available from each load-shedding/shifting event, and levels of incentives/rebates to compensate customer for their participation.

According to various embodiments, a Planning and Forecasting tool is targeted for one or more grid providers, examples of which include utilities (or utility-based customers), energy marketplaces, and wholesale electricity entities. For example, the tool estimates an amount of electricity that is projected to be reduced from the electrical grid during a forecast future DR event. This estimation may be based on historical data recorded for DR events that are similar to the forecast future DR event (e.g., time of year, cause of DR event, etc.), or based on machine learning techniques as described in further detail below. If the prediction of the reduction of electricity does not meet the demand requirements, then the grid provider (utility company/energy marketplace/wholesale electricity entity) may attempt to on-board additional participants in a DR management program to meet the electricity demands.

Furthermore, mobile application 142 installed at the client devices 140 of registered users may provide server computer 120 with near-real-time confirmation of participation in load-shedding for DR events. For example, server computer 120 receives—via an API (such as Open Automated Demand Response, i.e., “OADR”, or other) from a grid provider (utility customer/energy marketplace/wholesale energy entity)—electronic notification of an upcoming DR event. Server computer 120 then issues an alert/notification to the customer regarding an upcoming DR event to invite the customer to participate in load-shedding for an upcoming DR event. The alert/notification may be conveyed to a user of the customer in any way including via a GUI of mobile application 142 described herein, and/or via one or more alternative or additional communication methods, such as email, telephonic text message, automated telephone message, voice mail, a push notification at client device 140, etc. An alert may be tailored to the particular user, e.g., based on committed level of participation in a load shedding program. The user may communicate with server computer 120 to commit to participating in load-shedding for the upcoming DR event via a GUI control displayed in the alert or in any other way. The confirmation information may include the details of load-shedding actions authorized by the user, e.g., one or more of: one or more thermostats that are authorized to perform load-shedding actions, a target load-shedding setpoint for one or more thermostats associated with the user and a timeframe for load-shedding. Thus, server computer 120 has access to real-time user information regarding projected participation in load-shedding for the event. A load-shedding action may include target set-points or disablement of one or more energy sinks (such as turning off the thermostat or disconnecting one or more appliances, etc.).

In an embodiment, server computer 120 identifies one or more customers who, having already opted into a DR program at one tier, might upgrade to a higher tier during a potential DR event. Such identification helps if the grid provider has projected that there will be a significant supply-demand imbalance, in which the projected peak demand will exceed the available supply. Such identification may occur even before an upcoming DR event is identified. Such identification may involve identifying all customers who are not in the highest tier and providing them (e.g., through mobile application 142) with information about an upgrade. Alternatively, such identification may involve taking into account one or more attributes of lower tier customers (e.g., when the customers signed up, whether they have upgraded in the past, or if the customer has agreed to upgrade as indicated in the customer's configuration profile, what state(s) and/or city/cities their site(s) reside, a number of sites they own/are responsible for, an incentive offered in response to any past invitations to upgrade) and applying one or more pre-established rules on values of those attributes to determine a score that may be mapped to a predicted likelihood. Alternatively, identifying one or more customers involve identifying the one or more attributes and inserting values of those attributes in a machine-learned (ML) model that outputs a value (e.g., between 0 and 1) that represents a prediction of acceptance of a tier upgrade invitation. The training data upon which the ML model is trained may be based on (1) past instances of customers upgrading tiers in response to invitations to upgrade and (2) past instances of customers not upgrading tiers in response to invitations to upgrade. Regardless of how customers are identified, an invitation to upgrade their respective tiers may be sent to those customers, e.g., through their respective mobile applications.

According to various embodiments, after participation load-shedding for a DR event, mobile application 142 solicits feedback on participation in the event. For example, mobile application 142 provides a GUI with controls that allows a user (of a customer) to input feedback regarding one or more of: a level of satisfaction with participation in load-shedding, whether the customer is likely to participate again, reasons why or why not regarding future participation, and/or suggestions for improvement, etc. The customer/user feedback is sent to server computer 120, which may be used (with any other historical data recorded by server computer 120) to train one or more machine learning models 136 maintained by server computer 120.

In an embodiment, the GUI may include a drop-down menu of pre-defined options, each of which indicates a reason for opting out of a DR program. Different DR programs may be associated with different drop-down menus, indicating that there may be a first set of reasons why customers would opt out of one DR program and a second set of reasons why customers would opt out of another DR program. Also, there may be a drop down menu including upgrade options during DR events, indicating a willingness to upgrade to a higher tier during DR events.

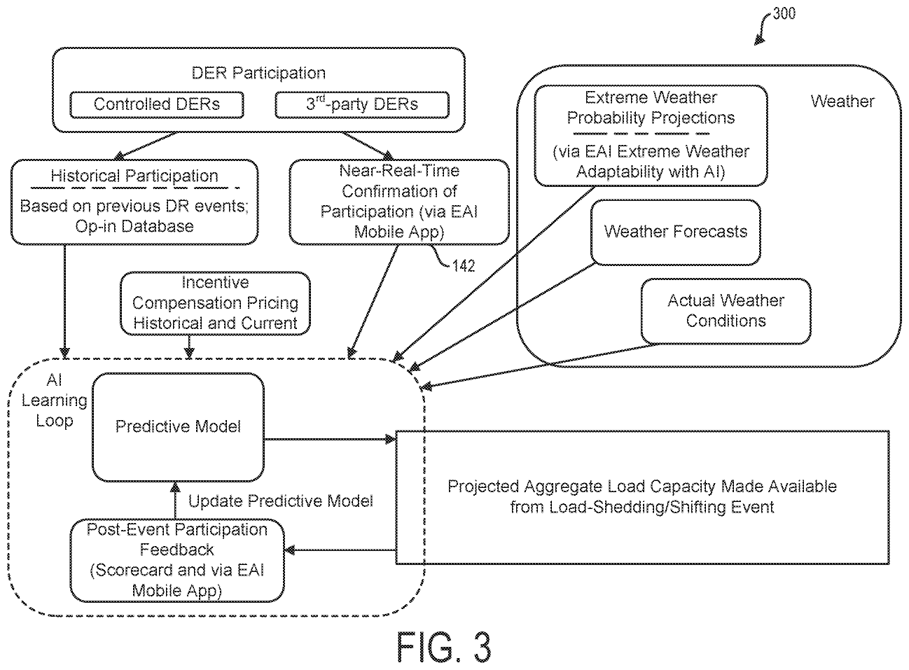

FIG. 3 depicts various input data that may be used to train one or more ML models 136 described herein, such as: historical DR event data for one or more historical DR events (such as historical participation in load-shedding for DR events), weather conditions at time of DR events, dates and times of DR events, business/enterprise activity data (including particular day(s) of the week and particular week(s) of the year) of DR events, numbers and characterizations (which could include type of business/enterprise, size of business/enterprise, geographical location, etc.) of DR customers who opted out of participation in load-shedding for DR events and timing of opting-out relative to the DR events, numbers and characterizations (which could include type of business/enterprise, size of business/enterprise, geographical location, etc.) of DR customers who opted into load-shedding for DR events and timing of opting-in relative to the DR events, historic load shedding program pricing models/amounts for incentive compensation, DERMs device settings (e.g. thermostat: SMS, IAT (inside air temperature), etc.) used for load-shedding, and feedback from a grid provider (utility company/energy marketplace/wholesale electricity entity) or sub-metering device on Megawatts (MWs) and Megawatt Hours (MWh) saved (electricity (load) shed) for DR events; information regarding customers that have committed to participate in load-shedding for an upcoming DR event; near-real-time confirmation of participation (e.g., via mobile application 142); weather information, such as extreme weather probability projections as described in the Extreme Weather Application incorporated herein, weather forecasts, detected actual weather conditions; post-event participation feedback information; historical and/or current pricing information (such as incentive compensation that is/was offered for participation in load-shedding); previous predictions generated by one or more ML models 136; etc.

A grid provider (utility company/energy marketplace/wholesale electricity entity) (and/or a DER aggregator) may use a planning and forecast tool to estimate the expected electricity (load) shed for a projected DR event. The machine learning techniques described herein can predict Megawatts (MWs) and Megawatt Hours (MWh) saved for the projected DR event. Other units may be used in other implementations. If the amount shed does not meet the electricity demand needs, then an entity (whether a grid provider or a DER aggregator) may then solicit additional DR participants to reduce the load on the electricity grid.

4.1. Load Forecasting Predictive Model for Load-Shedding/Peak Demand Management

According to various embodiments, an ML model 136 is trained to predict occurrence of DR events. For example, the ML model is trained using data points recorded in connection with historical DR events, including weather forecast data, accuracy of weather forecasting (e.g., as described in the Extreme Weather Application incorporated by reference herein). Using the trained ML model, a future DR event may be predicted by server computer 120. DR events are generally tied to extreme weather, given that extreme weather events generally upset the balance between, and status quo planning for, energy supply and demand. Examples of extreme weather events include heat wave, polar vortex, hurricane, tornado, flooding, droughts, and wildfires. For example, the presence of drought conditions may affect energy supply, especially if a significant percentage of energy supply is from hydro-technologies. As another example, a heat wave will require more air conditioning power to keep indoor spaces under cooling setpoints of local thermostats. As yet another example, the presence of wildfires in an area may affect the amount of sunlight reaching solar panels located in the area, which reduces the energy being produced by the solar panels that are available for use during the day. Thus, including weather forecasting and extreme weather probability projections in the training dataset for ML models that are configured to predict DR events results in more accurate DR event prediction.

According to various embodiments, an ML model 136 is trained to predict participation in load-shedding, which translates into load-shedding capacity, that is required to prevent overloading the electrical grid during a future DR event. For example, the ML model is trained using data points recorded in connection with historical DR events, including historical participation in load-shedding for DR events, weather conditions at time of DR events, dates and times of DR events, business/enterprise activity data (including particular day(s) of the week and particular week(s) of the year) of DR events, numbers and characterizations (which could include type of business/enterprise, size of business/enterprise, geographical location, etc.) of DR customers who opted out of participation in load-shedding for DR events and timing of opting-out relative to the DR events, numbers and characterizations (which could include type of business/enterprise, size of business/enterprise, geographical location, etc.) of DR customers who opted into load-shedding for DR events and timing of opting-in relative to the DR events, DERMS device settings (e.g. thermostat: SMS, IAT, etc.) used for load-shedding, and feedback from utility company/energy marketplace/wholesale electricity entity or sub-metering device on Megawatts (MWs) and Megawatt Hours (MWh) saved (electricity (load) shed) for DR events, or any other training data type described herein. Using the trained ML model, a level of load-shedding participation for a future DR event may be predicted by server computer 120. For example, the trained ML model produces a predicted number of customers that will participate in load-shedding, e.g., given a particular level of incentive compensation offered for participation.

In an embodiment, for HVAC management, server computer 120 captures certain characteristics of a site, such as current setpoint, inside air temperature (TAT), inside humidity, and outside air temperature (OAT). This provides additional insight into why customers might be opting in or out of DR programs. For example, if HVAC units are not reaching their respective set points (possibly due to a degraded unit or undersized unit) and the customer is uncomfortable, then the customer may be less likely to opt into a DR program.

According to various embodiments, an ML model 136 is trained to predict projected participation in load-shedding for a given DR event, e.g., based on one or more data points for the DR event, such as actual weather, weather forecasts, participation information for recent DR events, customer feedback data for the recent DR events, incentive compensation offered for participation in load-shedding, and participation information gathered from customers for the upcoming DR event. A prediction of projected participation in load-shedding for a future DR event may be compared to a prediction of a level of load-shedding projected for a future event to identify any projected shortfall.

In an embodiment, a first set of customers is determined for a future DR event, where each customer in the first set has already committed to participating in the future DR event. Also, a second set of customers is determined for the future DR event, where each customer in the second set has not committed to participating in the future DR event is determined. A level of load capacity that is made available from the first set of customers is estimated.

For the second set of customers, an ML model that is used to predict load capacity being made available from a customer is used or invoked for each customer in the second set. Thus, if there are one hundred customers, then the ML model may be invoked one hundred times in order to determine an aggregate of the predicted load capacity that might be made available if the second set of customers participate in the future DR event. If a customer has multiple sites (and/or multiple DERs per site) that will be affected by the future DR event, then the ML model may be invoked once for each of those sites or DERs. (Thus, some, but not all, DERs at a given site might participate in a DR event.) For example, the future DR event might have a first predicted temperature at one of the multiple sites and a second predicted temperature (that is different than the first predicted temperature) at another of the multiple sites. Also, coefficients of the ML model and their correspondence with certain characteristics (other than temperature) of the various sites (e.g., operating hours relative to the future DR event, type of industry in which the site is involved, such as retail versus fitness or 24-hour convenience store) that are input into the ML model may indicate that the customer (1) is likely to agree for one of the customer's sites to participate in the future DR event but (2) is not likely to agree for another of the customer's sites to participate in the future DR event.

If a customer declines participation in an upcoming DR event (e.g., by providing input, that indicates declining the invitation to participate, through a graphical user interface displayed, via mobile application 142, on a personal computing device), then server computer 120 uses that information to generate a training instance that is used to update the ML model.

In an embodiment, incentives are increased to stimulate participation in one or more DR programs and/or upgrades in tiers of participation in those DR programs. An ML model 136 may be trained to determine an amount or level of incentive that is needed to result in participation or an upgrade. The incentive may be in the form of direct compensation, tax credits, bill reduction, etc. The ML model 136 may be trained on an individual customer basis so that the ML model may be invoked at least once for each customer. Alternatively, the ML model 136 may be trained on a group of customers, such that the ML model 136 is invoked at least once for a group of customers and output of the ML model 136 represents an amount of incentive to offer to all customers in the group.

Furthermore, an ML model 136 may be trained to predict shortfall. According to various embodiments, the utility company/energy marketplace/wholesale electricity entity (“UC/MP/WS”) is aware of the demand needs for the next DR event. DERMs 100 provides the UC/MP/WS with the forecasted electricity shed at the next DR event. If the shed does not meet the demand, then the UC/MP/WS will request DERMs 100 to increase DR participants for load shedding programs (e.g., using various pricing incentives). According to various embodiments, the UC/MP/WS provides demand needs to DERMs 100 for the next DR event. DERMs 100 automatically reconciles demand and load shed requirements by initiating actions to increase DR participants for load shedding programs for the DR event.

Customer feedback and/or load-shedding participation information maintained by server computer 120 may be used to retrain ML model(s) 136 indicated above.

4.2. Identification of Energy Shortfall

Based on the information being received, e.g., via mobile application 142, regarding current commitment to load-shedding actions for an upcoming DR event, server computer 120 may determine that there will be a shortfall in energy supply during the DR event and that additional participation in the load-shedding program is necessary to avoid energy shortfall (e.g., a brownout). For example, one or more ML models 136 may be trained to predict an amount of load capacity that will be made available for an upcoming DR event. According to various embodiments, the training dataset comprises: historical DR event data (including one or more of historical load-shedding participation data, business/enterprise activity data (including particular day(s) of the week and particular week(s) of the year) of DR events, historical incentive compensation pricing data), and historical weather data (including for given customer geographical locations, historical records indicating one or more of extreme weather probability projections, weather forecast data, or detected weather conditions). The trained ML model is used to predict a load capacity made available for an upcoming DR event based, at least in part, on current DR event data (including one or more of: real-time load-shedding participation data for an upcoming DR event, or current incentive compensation pricing data), and weather data (including one or more of: extreme weather probability projections, weather forecast data, or detected weather conditions).

The prediction of the amount of load capacity that will be made available for a given DR event may be used to determine whether the amount of energy will be sufficient to avoid energy shortfall. Responsive to determining that the predicted load capacity made available for an upcoming DR event is not sufficient to balance the energy supply and demand during the upcoming DR event, one or more load capacity increasing actions are automatically performed by server computer 120. Examples of load capacity increasing actions include increasing incentive compensation offered for the upcoming DR event, increasing the level of participation of a set of dynamically-enrolled customers, or causing a request for additional participation in load-shedding to be sent to one or more customers.

According to various embodiments, a set of customers have enrolled in a load shedding program as “dynamically-enrolled” customers, which allow last-minute changes to the load-shedding actions scheduled to be taken by these customers for added incentive compensation. Based on forecasting of the amount of load-shedding (e.g., in MWs or MWhs) that must occur in order to avoid shortfall, server computer 120 determines what additional actions would satisfy the shortfall. Predicting what additional actions are needed may also be performed using one or more ML models 136.

4.3. Dynamically Adjusted Pricing

According to various embodiments, server computer 120 may identify dynamic pricing schemes for compensation to customers to incentivize participation in DR load-shedding, e.g., when expected participation is projected to fall short of the load-shedding needs for a particular DR event. The determination that expected participation in load-shedding for a particular DR event is projected to fall short may be based on ML models as described in further detail below.

Thus, DERMs 100 may use dynamic pricing applied to incentive compensation for customers, in conjunction with mobile application 142, to enroll more customer participants in load-shedding for an upcoming DR event, e.g., based on a predicted shortfall. One or more ML models 136 may be used to predict a level of compensation that is likely to incentivize the level of DER participation needed to satisfy the shortfall. According to various embodiments, one or more ML models may be trained based on training data comprising one or more of: historical load-shedding participation data, historical incentive compensation pricing data, and historical context data. Context data comprises one or more of extreme weather probability projections, weather forecast data, detected weather conditions, business/enterprise activity data (including particular day(s) of the week and particular week(s) of the year) of DR events, customer feedback data described below, or cost of living data.

For example, DERMs 100 receives a request to predict a level of incentive compensation for an upcoming DR event to result in a particular amount of load capacity being made available for the upcoming DR event (such as an amount of load capacity required to avoid energy shortfall during an upcoming DR event). DERMs 100 uses the trained machine-learning model to predict a level of incentive compensation based, at least in part, on real-time load-shedding participation data, current incentive compensation pricing data, and current context data, and returns, as a response to the request, the predicted level of compensation. As another example, a trained ML model can be used to predict a DR load shedding program opt-in/opt-out rate for a future DR event based on one or more incentive compensation packages that may be used for the load shedding program. From the predicted opt-in/opt-out rates, an expected shed rate is determined for the future DR event.

4.4. Pre-Conditioning Optimization for Load-Shedding/Shifting Events

In an embodiment, a learning loop on pre-conditioning is implemented to make sure that temperature stays within a particular range. Pre-conditioning actions (such as adjusting thermostat setpoints) may be used to prepare a space that will be the subject of one or more load-shedding actions for an upcoming DR event to prevent one or more undesirable conditions in the space during the load-shedding actions. For example, a DR event is predicted to occur between 6 PM and 9 PM during a heatwave (forecast temperature of 115° F. during the indicated timeframe). A customer has committed to increasing the cooling setpoint during the indicated timeframe to 90° F. Server computer 120 may automatically implement (or recommend via mobile application 142) one or more pre-conditioning actions to increase the likelihood that the air conditioner will remain off during the DR event, such as adjusting the cooling setpoint of the space from 74° F. to 65° F. three hours prior to the event. Furthermore, pre-conditioning actions may be configured to maintain the space at a particular comfort level that is lower than the load-shedding cooling setpoint committed to by the customer. For example, the customer may request pre-conditioning actions that will maintain the space at 85° F. or lower during the DR event.

In an embodiment, pre-conditioning is a configurable customer attribute, such that a customer who is willing to subject their building/space to pre-conditioning provides input indicating that willingness. Such input may be received through a smartphone application (as described herein), through a web portal online, or through a customer service representative over the telephone.

In an embodiment, one or more ML models 136 are trained to predict pre-conditioning actions that are likely to reduce energy usage, or maintain particular comfort criteria, during a DR event. According to various embodiments, the one or more ML models are trained using training data comprising one or more of: customer satisfaction information, historical DER behavior during DR events (e.g., IAT, OAT, setpoints, etc.), historical pre-conditioning actions taken in preparation for DR events, one or more environmental metrics during historical DR events, business activity data (including particular day(s) of the week and particular week(s) of the year) of DR events, or historical load-shedding actions taken during DR events. Based on customer configuration instructing automatic pre-conditioning, DERMs 100 uses the trained machine-learning model to predict one or more pre-conditioning actions to take for a particular space in preparation for an upcoming DR event. Prior to the upcoming DR event, DERMs 100 automatically causes the predicted one or more pre-conditioning actions to be taken for the particular space.

According to various embodiments, after the DR event, DERMs 100 receives customer feedback regarding the DR event from a user associated with the particular space, e.g., via mobile application 142 as described in further detail herein. DERMs 100 performs additional training of the machine-learning model based, at least in part, on the customer feedback. For example, the customer feedback from a customer is used to generate a new training instance that will be used to retrain a ML model. Training instances from more recent customer feedback may be given more weight in retraining a ML model than weight given to training instances from older customer feedback.

### 5. Phase 3: Real-Time Monitoring

In an embodiment, server computer 120 performs real-time monitoring during DR events of all participating DERs and customer sites. Thus, server computer 120 may include a database that stores a collection of all real-time data for set-points, IAT, OAT, and run-times, e.g., at 10 minute intervals and time-stamped. Such real-time data may be used to generate training instances that are used to train/retrain one or more ML models 136.

### 6. Phase 4: Dispatch and Controls

Software-defined grouping enables on a per-event basis the association of all participating DERs, sites and customers with predetermined temporary thermostat schedules for pre-conditioning and load-shedding events. Server computer 120 automatically downloads temporary schedules to all participating DERs to initiate pre-conditioning and load-shedding or shifting events, e.g., according to the level of commitment of the customer.

### 7. Phase 5: Notifications

In an embodiment, server computer 120 initiates alert notifications to customers at multiple intervals: in advance of an DR event; during the DR event on an hourly basis as a reminder; and after the event is completed. According to various embodiments, at the end of a DR event, a satisfaction questionnaire is generated and disseminated to customers (e.g., using mobile application 142) soliciting input from users of the customers.

In a related embodiment, server computer 120 also sends, to a customer, current setting information of DERs of the customer and various comfort levels during a DR event (e.g., IAT, Battery level, etc.). Such information may remind the customer regarding the DR program for which they signed up.

According to various embodiments, mobile application 142 includes a real-time notification tool for utilizing during DR events. For example, the real-time notification tool communicates alert notifications to customers (i.e., with a status of participation of a DER at a given site of a customer of a DR event) (a) in advance of the DR event; (b) during the DR event on (e.g., an hourly) basis as a reminder; and/or (c) after the DR event is completed.

### 8. Phase 6: Post-Event Analysis and Reporting

Post-event participation feedback from mobile application 142 recorded by server device 120 is used to further train the one or more ML models 136.

Customer feedback information measuring prediction vs. actual; learning loop to fine-tune one or more ML models 136. (One example of “prediction vs. actual” is predicted participation in a DR event and actual participation in the DR event. Another example of “prediction vs. actual” is predicated load shed for a DR event and actual load shed during the DR event.) Specifically, additional information from customer feedback may be used as a new training dataset (or to update an existing training dataset) for one or more ML models 136, which may or may not have been previously trained using other training data.

Server computer 120 may generate a summary of a DR event and send a summary to a user of a customer via email and/or mobile application 142. A summary may include a location of a DR event, what DERs were subject to the DR event, weather information related to the DR event (e.g., temperature, humidity, wind speed, air pressure), an amount of compensation that the customer earned, an indication of a number of events in which the customer's participated, a level of completion of the customer's participation commitment relative to the tier to which the customer subscribed, duration and settings of what the customer agreed to (e.g., 3 hours, 90 degrees, heating setpoint, cooling setpoint, pre-conditioning, etc.), and/or duration and settings of what actually happened (e.g., 2 hours and a high of 88 degrees).

Server computer 120 may also generate a summary of a DR event on an aggregate level (i.e., aggregating data from multiple sites of multiple customers) with statistical analysis (participation level, load reduction, opt-out level, etc.) for a DER aggregator and/or for a grid provider (the utility/energy marketplace/wholesale electricity entity) affected by a DR event. An example of statistical analysis includes illustrating the accuracy of a forecast load delivery compared to actual load delivered. Another example of statistical analysis includes analyzing customer demographics or other characteristics to illustrate the types of customers or customer characteristics that correlate with higher participation over time. For example, statistical analysis of participation in DR events might reveal that retail establishments have a 15% higher participation rate than manufacturing entities. As another example, statistical analysis of actual load reduction might reveal that customers in one county had 20% greater load reduction than customers in an adjacent county.

Similarly, server computer 120 may generate a summary of incentive compensation and send the summary to a customer via email and/or mobile application 142.

Also, server computer 120 may generate a summary of incentive compensation on an aggregate level (i.e., aggregating data from multiple sites of multiple customers) with statistical analysis for the grid provider.

8.1. Customer Satisfaction

Mobile application 142 facilitates post-event participation feedback by capturing customer satisfaction with a DR event and their likelihood to participate in a DR program in the future. Further, DR event summary reporting may be performed via mobile application 142. Mobile application 142 may further request reasons for dissatisfaction, which may be used by server computer 120 to identify trends in historical data, and may be used to predict future participation by using the data as training data for ML models. Furthermore, reasons for dissatisfaction may be used to adjust future load-shedding actions or pre-conditioning actions taken for the customer. For example, if a user of a customer expresses dissatisfaction that a space became too hot during the DR event, a commitment to pre-cooling prior to a similar future event may be made to the customer to make it more likely that the customer will participate in future load-shedding.

8.2. Analysis of Load-Shedding Results

Furthermore, server computer 120 records the results of load-shedding actions taken during a DR event, including the amount of time air-conditioning or heating was engaged in a space during the DR event. Based on this information, server computer 120 analyzes the effectiveness of load-shedding actions. Furthermore, this information may be used to continually train one or more ML models 136 that are trained to predict pre-conditioning actions to take for a given DR event. According to various embodiments, a grid provider (utility company/energy marketplace/wholesale electricity entity) or sub-metering device provides DERMs 100 with information regarding a number of Megawatts (MWs) and Megawatt Hours (MWhs) saved (electricity shed) for a specific DR event.

### 9. Aggregation of Third-Party Ders

Many of the DERs described herein (such as DERs 104A-N) are under the direct control of DERMs 100, examples of which include thermostats, rooftop controls for ventilation (demand control ventilation “DCV”) and/or fans (variable speed drive “VSD” controls), etc. More specifically, a DER that is directly controlled by DERMs 100 uses DERMs 100 as a control system, e.g., as described in one or more of the applications incorporated by reference herein. A control system of a DER is configured to send instructions to the DER to cause the DER to perform one or more operations. A given site with DERs that are under the direct control of DERMs 100 may also include one or more DERs that are not under the direct control of DERMs 100, which are referred to herein as “third-party DERs”. Third-party DERs may include solar cells with battery storage, commercial EV fleets, back-up generators, etc., that operate at a given site with directly-controlled DERs.

Even though DERMs 100 does not directly control third-party DERs, these DERs may be aggregated using DERMs 100. Sites that include DERs that DERMs 100 is configured to control will increasingly include third-party DERs, and the ability to leverage these third-party DERs for energy resource management provides additional flexibility for the management process.

Initially, third-party DERs may be considered as being in one of four operational modes: (A) ‘island-mode’ not connected to the electrical grid at all and independently powered, e.g., by DER-specific solar panels; (B) ‘demand-mode’ connected to the grid as a demand entity, i.e., drawing electricity to recharge; (C) ‘bi-directional-mode’ connected to the grid in a two-way fashion, in which the DERs can put electricity back on the grid in the same way that residential solar panels do today for net-metering; or (D) ‘provider-mode’ connected to the grid as a source entity, i.e., providing electricity as a back-up, e.g., via natural gas or diesel-fueled generators.

However, there is a fifth mode to consider, one that does not exist yet: an ‘integrated-mode’. Specifically, a grid provider (the utility/energy marketplace/wholesale electricity entity) might want these third-party DERs, owned or leased by light commercial customers, to be integrated into the peak-demand management processes and systems. If DERMs 100 is already controlling one or more DERs, e.g., a customer's thermostats, at sites that host third-party DERs, then the grid provider (utility/energy marketplace/wholesale electricity entity) might want DERMs 100 to also integrate the third-party DERs into the overall peak demand management processes and systems.

Thus, according to various embodiments, DERMs 100 integrates third-party DERs operating in bi-directional-mode or provider-mode into management processes to cause these third-party DERs to also operate in integrated-mode. For third-party DERs in integrated-mode, the DERMs 100 utilizes an API to integrate with these third-party DERs. This API enables bringing information from third-party DERs into the load-shedding forecasting calculations described herein. As a DER aggregator, it is possible to integrate these third-party DERs via this API. In doing so, at a given site, one or more third-party DERs operating in integrated-mode may be utilized in conjunction with load-shedding operations (e.g., through thermostat controls, such as by turning up the set point to 90 degrees during a heatwave event for two hours, by turning down the set point to 55 degrees during the duration of a winter storm, or by turning on a fan automatically in place of running an air conditioner) to efficiently manage energy requirements of the electricity grid. Similar to non-third-party DER management actions, examples of third-party DER management for DR events include: optimizing battery storage to ensure optimal battery energy availability during a DR event (that is, assure batteries are fully charged prior to the DR event, which allows a building to operate off the charged batteries during a DR event to lessen the requirements on the energy grid); disable third-party DER charging during DR events; selectively enable third-party DER charging during one or more DR events based on DR event attributes, etc.

As such, a combined forecast is generated of available load from a site with both directly controlled and third-party DERs that takes into account both load-shedding forecasting described above and load-shedding forecasting for the one or more third-party DERs. If such a site is multiplied by the thousands in a given area of a grid provider (utility company/energy marketplace/wholesale electricity entity), then it becomes both an opportunity—for greater peak demand capacity—and a significantly more complex forecasting problem to solve.

According to various embodiments, machine learning (ML) models 136 include one or more ML models that are trained, based on one or more types of training data described above, and that are configured to predict load-shedding capabilities arising from third-party DERs. Predictions for third-party DERs may be generated based on the same ML models as described above, or based on ML models that are specifically trained for third-party DER predictions. According to various embodiments, one or more of ML models 136 are trained based on feedback from a grid provider (utility company/energy marketplace/wholesale electricity entity) or sub-metering device that provides MWs or MWhs saved (electricity shed) for past DR events.

In addition, the availability of third-party DERs at customer locations will change over time, for a variety of reasons, including: third-party DERs being installed or dismantled, whether the third-party DERs are charged properly or are able to provide electricity into the system at the time of need, whether the third-party DERs are plugged in at the time of need, etc. Thus, third-party DER availability may influence machine learning (ML) models 136 (e.g., the forecasting model). Accordingly, historical data for third-party DER availability may be included in training data sets and input data for one or more of ML models 136 to account for the varying electricity supply from this source.

Incentive compensation and informational programs described herein may be configured to incentivize customers with third-party DERs to participate in load-shedding events. For example, mobile application 142 may display information regarding one or more of: a number of third-party DERs registered for the customer, connectivity of the third-party DERs registered for the customer, etc. Also, a customer with more third-party DERs registered to their account may automatically be eligible for a higher tier of incentivization for participation in load-shedding events. In this case, mobile application 142 may display information regarding the elevated tier, and/or how the customer may elevate incentivization tiers for incentive compensation by registering a certain number of additional third-party DERs.

### 10. System Overview

As depicted in FIG. 1, DERMs 100 includes a server computer 120 which implements DERMs techniques described herein for one or more sites, such as a site that uses DER system 102. In this context, a site generally refers to a building or series of buildings that are located in a geographic location. While FIG. 1 depicts a DER system 102, of example DERMs 100, comprising a single site, a DERMs may control DERs at multiple sites at multiple geographic locations and of multiple customers. In various embodiments, DER system 102 is coupled through a router 110 to a network 150, which may represent the Internet or a local area network, and through network 150 to server computer 120.

Example DER system 102 includes DERs 104A-N (representing any number of DERs) communicatively coupled to a local network 112 that has connectivity to network 150. Each of the DERs 104A-N communicates over local network 112, e.g., using wireless connections that, for example, use the Wi-Fi communication standard. For example, router 110 may comprise a wireless access point that facilitates communication between any wireless ventilation device and network 150. In some embodiments, router 110 may be the same router that is used for communication with other computer devices at the site, such as point of sale terminals, inventory computers, or special-purpose computers; in other words, embodiments of the systems and solutions described herein do not require a dedicated router, but can use available bandwidth of a router that is already installed at the site for other purposes.

Network 150 may comprise a plurality of public internetworks providing connectivity between DER system 102 and server computer 120. In various embodiments, network 150 may comprise a private point-to-point connection of a site to the server computer 120. For example, a client computing device located at the site of DER system 102 could use the public Internet to connect to server computer 120 for system configuration and reporting purposes, but a private point-to-point connection may be provided for the collection of data from DERs 104A-N. For example, a point-to-point connection could be implemented using an Internet Protocol Security (IPsec) network tunnel or other mechanism providing a secure connection over which collected data may be transmitted. In various embodiments, the secure connection may be made compliant with the Payment Card Industry (PCI) security standards such that the collected data may be transmitted over the same network elements and through network firewalls used by various sites to securely transmit credit cardholder information.

Server computer 120 comprises a DERMs platform and a collection of DERMs applications and modules, each of which is detailed in other sections below. In general, the DERMs applications and modules of server computer 120 are configured to perform one or more aspects of the phased DERMs approach described herein.

In various embodiments, server computer 120 comprises an application programming interface (API) 122, DERMs service 124, and DERMs applications 130. The modules depicted in FIG. 1 are provided as examples, and server computer 120 may comprise any number of additional modules including logging, system administration, and other modules or sub-modules.

In various embodiments, DERMs service 124 and DERMs applications 130 interface with DER system 102 and/or a client device 140 using API 122 that implements DERMs functions/phases. API 122 may provide controlled third-party access to various statistical views, collected energy usage/management and measurement data, device templates, and other information. In this manner, data collected and stored in server computer 120 may be provided as a data asset to various third parties including industry analysts, DER manufacturers, utility providers, and others. API 122 may additionally allow server computer 120 to control DERs in DER system 102 and/or obtain analytics from DERs and/or measurement devices.

DERMs service 124 comprises a graphical user interface (GUI) instructions 126 and data collection instructions 128. The GUI instructions 126 comprise computer-readable instructions that, when executed by one or more processers of server computer 120, cause server computer 120 to generate graphical user interface data that, when interpreted, causes display of a graphical user interface on a display device that is associated with server computer 120 or with client device 140. The server computer 120 may be configured to generate graphical user interface information for, and cause display of, a DERMs interface comprising one or more informational dashboards, DR event opt-in information (such as compensation offers, and levels of enrollment, as well as providing the ability to opt into load-shedding for an upcoming DR event), customer feedback forms, and other interfaces that facilitate user interaction with the DER system, such as analytics and reports, alerts and alarms, configuration options, schedules, etc. The server computer 120 may be further configured to generate graphical user interface information for, and cause display of, a DERMs interface configured to perform one or more customer satisfaction (retention) actions, such as keeping customers abreast of active DR events, offering multiple DR options/plans, offering compensation to customers to incentivize participation in load-shedding events, establishing customer satisfaction/engagement tools/reports, and/or providing customers with up-to-date incentive compensation pricing and energy savings information, and/or DIY installation instructions for one or more types of DERs. In various embodiments, graphical user interface data generated based on GUI instructions 126 may be accessed using a computer, such as client device 140 over a network, e.g., based on mobile application 142 on client device 140 requesting graphical user interface data via network 150 and, in response, server computer 120 sending graphical user interface data for displaying a GUI on a screen of client device 140. In this example, a user at client device 140 interacts with DERMs service 124 via the displayed GUI.

Client device 140 may be any computing device capable of requesting services over a network such as, for example, personal computers, workstations, laptop computers, netbook computers, smartphones, and tablet computers. As an example, client device 140 may comprise a browser that can access HTML documents generated based on GUI instructions 126.

In various embodiments, based on GUI instructions 126, mobile application 142 may generate GUI displays that are customized for particular devices. For example, in response to requests for similar information, mobile application 142 may generate one display in response to detecting that client device 140 is a smartphone, and a second display in response to detecting that client device 140 is a personal computer. In various embodiments, the generation of informational dashboards, configuration pages, and other displays may be customized, e.g., using Responsive Web Design, for more effective display depending on various characteristics of the client device including, for example, screen size and resolution, processing power, presence of a touch user interface, and connection bandwidth.

In various embodiments, mobile application 142 may control access to DERMs 100 based on user access credentials supplied by a user accessing mobile application 142. In various embodiments, each authorized user may be associated with a customer profile (or user profile) that identifies the DERs associated with the customer (or user). In various embodiments, a user's access level may include one or more specific sites or locations that the user is authorized to view and/or configure, etc.

In various embodiments, a user accessing mobile application 142 may define and configure various aspects of DER system 102 in accordance with the customer's/user's profile and corresponding access levels. For example, a user may use mobile application 142 to opt into a particular load-shedding event, establish levels of participation in peak management programs, etc., as further described in other sections.

Data collection instructions 128 comprise computer-readable instructions that, when executed by one or more processers of server computer 120, cause server computer 120 to collect and store historical DERMs information, such as: historical participation in load-shedding for a DR event; statistics regarding DR events including dates, demand numbers, supply numbers, forecast data from third-party forecast sources, actual load shed in kWh and MWh, etc.

Server computer 120 may further comprise DERMs applications 130 that provide centralized management/aggregation of DER systems across any number of locations. DERMs applications 130 may include automated control instructions 132, analytics instructions 134, one or more machine learning models 136, and/or alert and alarm instructions 138.

Automated control instructions 132 comprise computer-readable instructions that, when executed by one or more processors, cause server computer 120 to control one or more DERs of DER system 102. For example, server computer 120 sends instructions to DER system 102 that, when executed, cause a pre-conditioning action to be performed by a conditioning DER.

Analytics instructions 134 comprise computer-readable instructions that, when executed by one or more processors, cause server computer 120 to generate analytics based on historical or real-time information regarding DER participation, weather, incentive compensation pricing, etc. The analytics may include processing needed to prepare the information to generate training data to train one or more ML models 136 using one or more machine learning techniques.

Alert and alarm instructions 138 that, when executed, may further cause server computer 120 to generate one or more alerts and/or alarms, e.g., for display within a GUI of mobile application 142 described herein, and/or for communication with a user via one or more alternative or additional communication methods, such as email, telephonic text message, automated telephone message, voice mail, a push notification at client device 140, an alert via an application or GUI displayed at client device 140, etc. For example, server computer 120 may generate an alert that a DR event is upcoming with an invitation to enroll in load-shedding for the event.

### 11. Machine Learning

According to various embodiments, server computer 120 maintains one or more machine learning (ML) models 136, which are used to perform one or more machine learning-based techniques for DERMs 100, such as load forecasting predictive model for load-shedding/peak demand management, and pre-conditioning optimization for load-shedding/shifting events. Using machine learning for DERMs 100 increases the effectiveness of DER management performed by the system, and allows for better results for systems that opt into DR management programs, e.g., by predicting pre-conditioning actions to perform in preparation for a DR event. ML model uses include predicting 1\4 W and MWh load-shed based on a specific up and coming DR event; predicting customer savings based on DR events and incentive compensation packages enrolled; predicting when pre-conditioning is needed, etc.

A machine learning model is trained using a particular machine learning algorithm. Once trained, input is applied to the machine learning model to make a prediction, which may also be referred to herein as a predicted output or output.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output, as described above. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or one or more other criteria are met.

In a software implementation, when a machine learning model is referred to as receiving an input, executed, and/or as generating an output or prediction, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e., configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C #, Ruby, Lua, Java, Matlab, R, and Python.

11.1. Artificial Neural Networks

An artificial neural network (ANN) is a machine learning model that, at a high level, models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to as hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input node, the activation value is simply an input value for the input. For an activation neuron, the activation value is the output of the respective activation function of the activation neuron.

Each edge from a particular node to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation node, the activation function of the neuron is applied to the weighted activation values and the bias.

11.2. Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of nodes in layer L−1 and L is N[L−1] and N[L], respectively, the dimensions of matrix W are N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input node. The particular input may be stored as vector. Training data comprises multiple inputs, each being referred to as sample in a set of samples. Each sample includes a value for each input node. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every node in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of nodes and/or edges determines the size of matrices needed to implement a neural network. The smaller the number of nodes and edges in a neural network, the smaller matrices and amount of memory needed to store matrices. In addition, a smaller number of nodes and edges reduces the amount of computation needed to apply or train a neural network. Less nodes means less activation values need be computed, and/or less derivative values need be computed during training.

Properties of matrices used to implement a neural network correspond neurons and edges. A cell in a matrix W represents a particular edge from a node in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e., number of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

11.3. Backpropagation

An ANN's output may be more or less correct. For example, an ANN that recognizes letters may mistake an I as an L because those letters have similar features. Correct output may have particular value(s), while actual output may have different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. The gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper the gradient, the larger the adjustment. Not all edge weights are adjusted by the same amount. As model training continues with additional input samples, the error of the ANN should decline. Training may cease when the error stabilizes (i.e., ceases to reduce) or vanishes beneath a threshold (i.e., approaches zero). Example mathematical formulae and techniques for feedforward multilayer perceptron (MLP), including matrix operations and backpropagation, are taught in a related reference “Exact Calculation Of The Hessian Matrix For The Multi-Layer Perceptron,” by Christopher M. Bishop, the entire contents of which are hereby incorporated by reference as if fully set forth herein.

Model training may be supervised or unsupervised. For supervised training, the desired (i.e., correct) output is already known for each example in a training set. The training set is configured in advance by (e.g., a human expert, or via the labeling algorithm described above) assigning a categorization label to each example. For example, the training set for a given ML model is labeled, by an administrator, with the workload types and/or operating systems running on the server device at the time the historical utilization data was gathered. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. A supervised or unsupervised ANN model may be elevated as a first class object that is amenable to management techniques such as monitoring and governance during model development such as during training.

11.4. Deep Context Overview

As described above, an ANN may be stateless such that timing of activation is more or less irrelevant to ANN behavior. For example, recognizing a particular letter may occur in isolation and without context. More complicated classifications may be more or less dependent upon additional contextual information. For example, the information content (i.e., complexity) of a momentary input may be less than the information content of the surrounding context. Thus, semantics may occur based on context, such as a temporal sequence across inputs or an extended pattern (e.g., compound geometry) within an input example. Various techniques have emerged that make deep learning contextual. One general strategy is contextual encoding, which packs a stimulus input and its context (i.e., surrounding/related details) into a same (e.g., densely) encoded unit that may be applied to an ANN for analysis. One form of contextual encoding is graph embedding, which constructs and prunes (i.e., limits the extent of) a logical graph of (e.g., temporally or semantically) related events or records. The graph embedding may be used as a contextual encoding and input stimulus to an ANN.

Hidden state (i.e., memory) is a powerful ANN enhancement for (especially temporal) sequence processing. Sequencing may facilitate prediction and operational anomaly detection, which can be important techniques. A recurrent neural network (RNN) is a stateful MLP that is arranged in topological steps that may operate more or less as stages of a processing pipeline. In a folded/rolled embodiment, all of the steps have identical connection weights and may share a single one-dimensional weight vector for all steps. In a recursive embodiment, there is only one step that recycles some of its output back into the one step to recursively achieve sequencing. In an unrolled/unfolded embodiment, each step may have distinct connection weights. For example, the weights of each step may occur in a respective column of a two-dimensional weight matrix.

A sequence of inputs may be simultaneously or sequentially applied to respective steps of an RNN to cause analysis of the whole sequence. For each input in the sequence, the RNN predicts a next sequential input based on all previous inputs in the sequence. An RNN may predict or otherwise output almost all of the input sequence already received and also a next sequential input not yet received. Prediction of a next input by itself may be valuable. Comparison of a predicted sequence to an actually received (and applied) sequence may facilitate anomaly detection, as described in detail above.

Unlike a neural layer that is composed of individual neurons, each recurrence step of an RNN may be an MLP that is composed of cells, with each cell containing a few specially arranged neurons. An RNN cell operates as a unit of memory. An RNN cell may be implemented by a long short term memory (LSTM) cell. The way LSTM arranges neurons is different from how transistors are arranged in a flip flop, but the same theme of a few control gates that are specially arranged to be stateful is a goal shared by LSTM and digital logic. For example, a neural memory cell may have an input gate, an output gate, and a forget (i.e., reset) gate. Unlike a binary circuit, the input and output gates may conduct an (e.g., unit normalized) numeric value that is retained by the cell, also as a numeric value.

An RNN has two major internal enhancements over other MLPs. The first is localized memory cells such as LSTM, which involves microscopic details. The other is cross activation of recurrence steps, which is macroscopic (i.e., gross topology). Each step receives two inputs and outputs two outputs. One input is external activation from an item in an input sequence. The other input is an output of the adjacent previous step that may embed details from some or all previous steps, which achieves sequential history (i.e., temporal context). The other output is a predicted next item in the sequence.

Sophisticated analysis may be achieved by a so-called stack of MLPs. An example stack may sandwich an RNN between an upstream encoder ANN and a downstream decoder ANN, either or both of which may be an autoencoder. The stack may have fan-in and/or fan-out between MLPs. For example, an RNN may directly activate two downstream ANNs, such as an anomaly detector and an autodecoder. The autodecoder might be present only during model training for purposes such as visibility for monitoring training or in a feedback loop for unsupervised training. RNN model training may use backpropagation through time, which is a technique that may achieve higher accuracy for an RNN model than with ordinary backpropagation.

11.5. Random Forest

Random forests or random decision forests are an ensemble of learning approaches that construct a collection of randomly generated nodes and decision trees during the training phase. The different decision trees are constructed to be each randomly restricted to only particular subsets of feature dimensions of the dataset. Therefore, the decision trees gain accuracy as the decision trees grow without being forced to over fit the training data as would happen if the decision trees were forced to be restricted to all the feature dimensions of the dataset. Predictions for the time-series are calculated based on the mean of the predictions from the different decision trees.

The following is an example and non-limiting method of training a set of Random Forest models. A best trained Random Forest ML model is selected, from a set of models resulting from the training phase, to be the basis for instances of a trained ML model. In some embodiments, training data is pre-processed prior to labeling the training data that will be used to train the Random Forest ML model. The pre-processing may include cleaning the readings for null values, normalizing the data, downsampling the features, etc.

In an embodiment, hyper-parameter specifications are received for the Random Forest tch ML model to be trained. Without limitation, these hyper-parameters may include values of model parameters such as number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc. The Random Forest ML model is trained using the specified hyper-parameters and the training dataset (or the pre-processed sequence training data, if applicable). The trained model is evaluated using the test and validation datasets, as described above.

According to embodiments, a determination is made of whether to generate another set of hyper-parameter specifications. If so, another set of hyper-parameter specifications is generated and another Random Forest ML model is trained having the new set of hypermeters specified. All Random Forest ML models trained during this training phase are the set of models from which the best trained ML model is chosen.

### 12. Hardware Overview

Training datasets for ML model(s) 136 may reside in volatile and/or non-volatile storage, including persistent storage or flash memory, or volatile memory of computing device 100. Additionally, or alternatively, one or more of the training dataset may be stored, at least in part, in main memory of a database server computing device.

An application, such as mobile application 142, runs on a computing device and comprises a combination of software and allocation of resources from the computing device. Specifically, an application is a combination of integrated software components and an allocation of computational resources, such as memory, and/or processes on the computing device for executing the integrated software components on a processor, the combination of the software and computational resources being dedicated to performing the stated functions of the application.

One or more of the functions attributed to any process described herein may be performed by any other logical entity that may or may not be depicted in FIG. 1, according to one or more embodiments. In an embodiment, each of the techniques and/or functionality described herein is performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

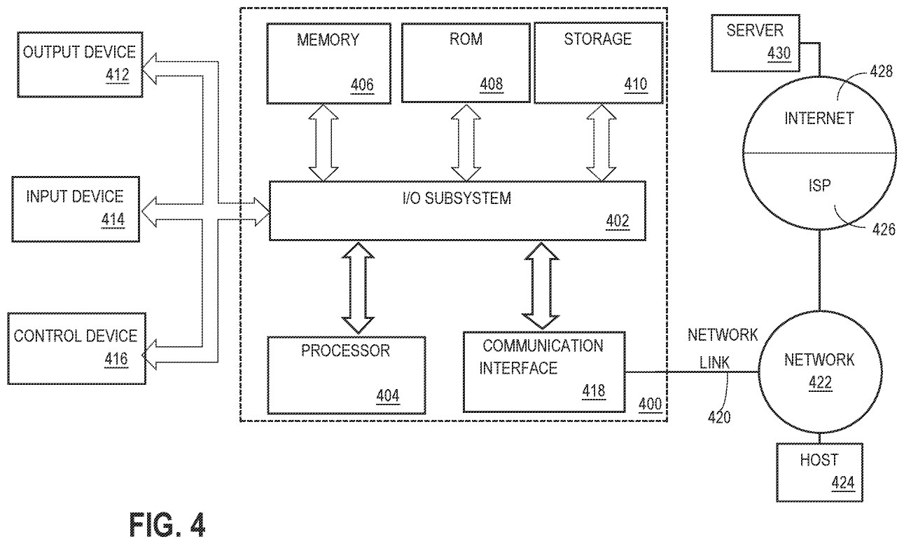

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 13. Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
training a machine-learning model based on a training dataset comprising one or more of: historical demand response (DR) event data and historical weather data;
using the trained machine-learning model to predict a load capacity to be made available for an upcoming DR event based, at least in part, on current DR event data and weather data;
determining, based, at least in part, on the predicted load capacity made available for an upcoming DR event, that there is not sufficient load capacity to balance energy supply and demand during the upcoming DR event; and
responsive to determining that the load capacity is not sufficient to balance the energy supply and demand during the upcoming DR event, automatically performing one or more load capacity increasing actions;
wherein the method is performed by one or more computing devices.

2. The method of claim 1, wherein the historical DR event data comprises historical load-shedding participation data for historical DR events.

3. The method of claim 1, wherein the historical DR event data comprises historical incentive compensation data.

4. The method of claim 1, wherein weather data comprises one or more of: extreme weather probability projections, weather forecast data, or detected weather conditions.

5. The method of claim 1, wherein the current DR event data comprises one or more of: real-time load-shedding participation data for an upcoming DR event or current pricing data for incentive compensation.

6. The method of claim 1, wherein a load capacity increasing action comprises one of: increasing incentive compensation offered for the upcoming DR event, increasing a level of participation of a set of dynamically-enrolled users, or causing a request for additional participation in increasing load capacity to be sent to one or more users.

7. The method of claim 6, wherein the load capacity increasing action includes causing the request for additional participation in increasing load capacity to be sent to a plurality of customers, the method further comprising:
receiving a plurality of responses from the plurality of customers, wherein each response in a subset of the plurality of responses indicates approval in participating in increasing load capacity for the upcoming DR event.

8. The method of claim 7, wherein:
a first response of the plurality of responses, from a first customer, indicates approval in participating in load shedding, and
a second response of the plurality of responses, from a second customer, indicates approval in participating in adding load supply.

9. The method of claim 1, further comprising:
determining a first load capacity to be made available for the upcoming DR event based on a set of customers that have agreed to participate in the upcoming DR event;
aggregating the first load capacity with the predicted load capacity to generate an aggregated load capacity to be made available for the upcoming DR event;
wherein determining that there is not sufficient load shed is also based on the aggregated load capacity.

10. A computer-executed method comprising:
training a machine-learning model based on a training dataset comprising historical load-shedding participation data, historical incentive compensation data, and historical context data;
receiving a request to predict a level of incentive compensation for an upcoming DR event to result in a particular amount of load capacity made available for the upcoming DR event;
using the trained machine-learning model to predict a level of incentive compensation based, at least in part, on real-time load-shedding participation data, current incentive compensation data, and current context data;
returning, as a response to the request, the predicted level of incentive compensation;
wherein the method is performed by one or more computing devices.

11. The method of claim 10, wherein the context data comprises one or more of extreme weather probability projections, weather forecast data, detected weather conditions, activity data of DR events, customer feedback data, or cost of living data.

12. The method of claim 10, wherein an input to the machine-learning model is an input compensation amount from a grid provider.

13. A computer-executed method comprising:
training a machine-learning model based on a training dataset based on a training dataset comprising one or more of: customer satisfaction information, historical DER behavior during DR events, historical activity data of DR events, historical pre-conditioning actions taken in preparation for DR events, one or more environmental metrics during historical DR events, or historical load-shedding actions taken during DR events;
using the trained machine-learning model to predict one or more pre-conditioning actions to take for a particular space in preparation for an upcoming DR event;
prior to the upcoming DR event, automatically causing the predicted one or more pre-conditioning actions to be taken for the particular space;
wherein the method is performed by one or more computing devices.

14. The computer-executed method of claim 13, further comprising:
after the upcoming DR event has occurred and becomes a past DR event, receiving customer feedback regarding the past DR event from a user associated with the particular space;
performing additional training of the machine-learning model based, at least in part, on the customer feedback.

15. One or more storage media storing instructions which, when executed by one or more processors, cause performance of the method recited in claim 1.

16. One or more storage media storing instructions which, when executed by one or more processors, cause performance of the method recited in claim 2.

17. One or more storage media storing instructions which, when executed by one or more processors, cause performance of the method recited in claim 3.

18. One or more storage media storing instructions which, when executed by one or more processors, cause performance of the method recited in claim 4.

19. One or more storage media storing instructions which, when executed by one or more processors, cause performance of the method recited in claim 10.

20. One or more storage media storing instructions which, when executed by one or more processors, cause performance of the method recited in claim 13.
